(19) United States
(12) Patent Application Publication
(10) Pub. No.: US 2025/0204298 A1
(43) Pub. Date: Jun. 26, 2025

(54) AGRICULTURAL VEHICLE WITH VISUAL MONITORING SYSTEM

(71) Applicant: Raul Mendoza Cazares, Fresno, CA (US)

(72) Inventor: Raul Mendoza Cazares, Fresno, CA (US)

(21) Appl. No.: 18/391,238

(22) Filed: Dec. 20, 2023

(51) Int. Cl. A01B 69/00

(52) U.S. Cl. CPC A01B 69/001

(57) ABSTRACT

An agricultural vehicle for driving between rows of trees includes a body which is sized and configured to fit between rows of plants. The body is elongated between a front end and a rear end and comprises a main portion and a cabin, with the cabin being coupled to and positioned forwardly of the main portion. A plurality of wheels is mounted to the body, and the wheels are sized, positioned, and configured to fit between the rows of plants. A plurality of cameras is provided for monitoring an entire perimeter region surrounding the body, the images of which are selectively presented on a display in the cabin.

### (B) CROSS-REFERENCE TO RELATED APPLICATIONS

Not Applicable

### (C) STATEMENT REGARDING FEDERALLY SPONSORED RESEARCH OR DEVELOPMENT

Not Applicable

### (D) THE NAMES OF THE PARTIES TO A JOINT RESEARCH AGREEMENT

Not Applicable

### (E) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (F) STATEMENT REGARDING PRIOR DISCLOSURES BY THE INVENTOR OR JOINT INVENTOR

Not Applicable

### (G) BACKGROUND OF THE INVENTION

### (1) Field of the Invention

The disclosure relates to agricultural vehicles and more particularly pertains to a new agricultural vehicle for driving between rows of trees.

### (2) Description of Related Art Including Information Disclosed Under 37 CFR 1.97 and 1.98

Various tractors for operation in agricultural tasks and monitoring systems for visually monitoring areas around an agricultural vehicle are disclosed by the prior art. However, the prior art fails to describe an agricultural vehicle sized and shaped for driving between rows of trees in an orchard or similar environment which has a plurality of cameras for monitoring an entirety of a perimeter region that surrounds the vehicle. Such an apparatus would be useful in maneuvering the vehicle such that the vehicle does not collide with the surrounding trees or with individuals moving near the vehicle.

### (H) BRIEF SUMMARY OF THE INVENTION

An embodiment of the disclosure meets the needs presented above by generally comprising a body which is sized and configured to fit between rows of plants. The body is elongated between a front end and a rear end and comprises a main portion and a cabin, with the cabin being coupled to and positioned forwardly of the main portion. A plurality of wheels is mounted to the body, and the wheels are sized, positioned, and configured to fit between the rows of plants. A drive system is mounted in the main portion of the body and is operatively coupled to at least one of the plurality of wheels. A control system is mounted in the cabin of the body and is operatively coupled to the drive system. A plurality of cameras is mounted on an exterior of the body, and the cameras are oriented to face outwardly from the body. A processor is operatively coupled to the plurality of cameras, and a display is operably coupled to the processor. The display is mounted in the cabin, and the processor is configured to cause the display to present images of an entire perimeter region surrounding the body captured by the cameras.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (I) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side in-use view of an agricultural vehicle according to an embodiment of the disclosure.

FIG. 2 is a front in-use view of an embodiment of the disclosure.

FIG. 3 is a back view of an embodiment of the disclosure.

FIG. 4 is a top view of an embodiment of the disclosure.

FIG. 5 is a block diagram of an embodiment of the disclosure.

### (J) DETAILED DESCRIPTION OF THE INVENTION

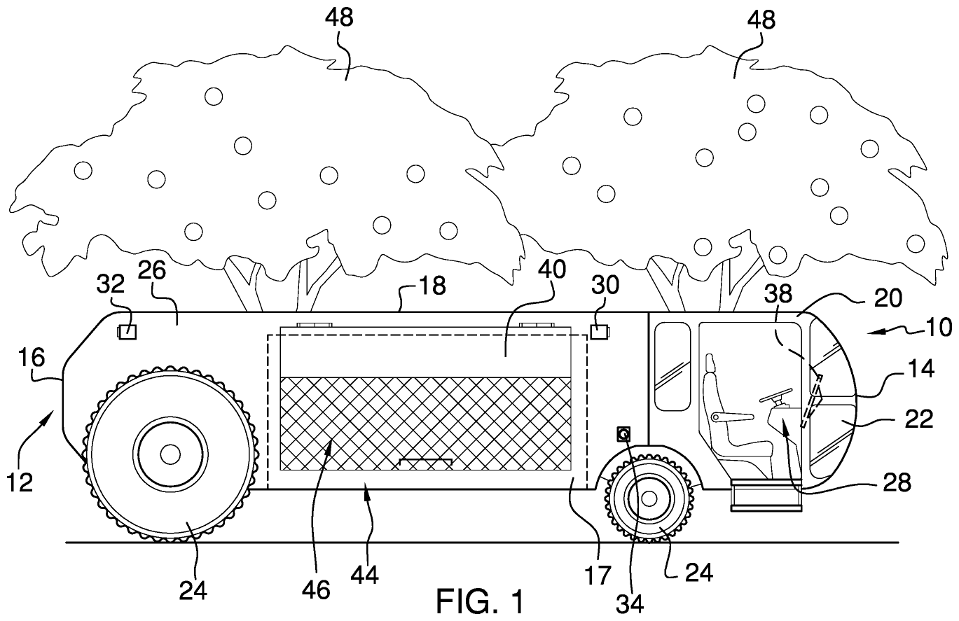

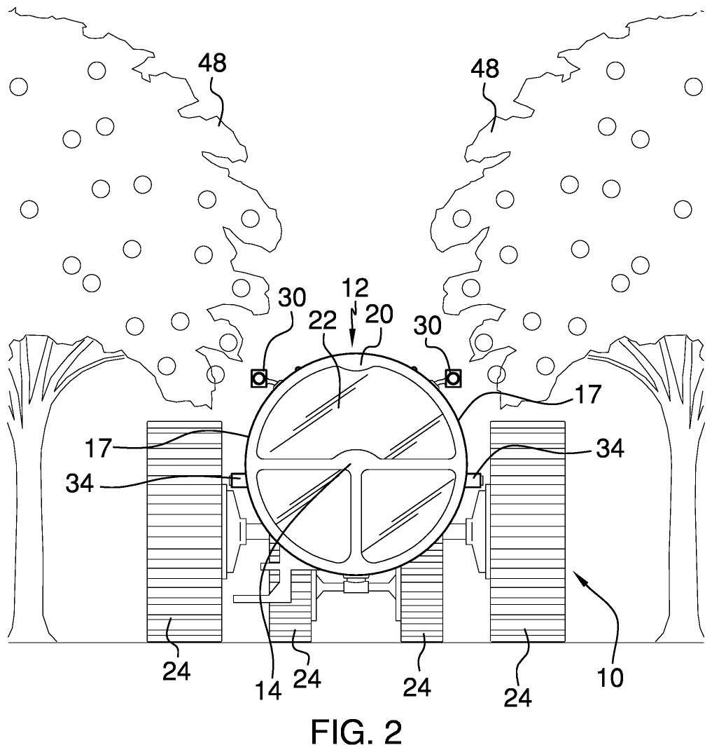

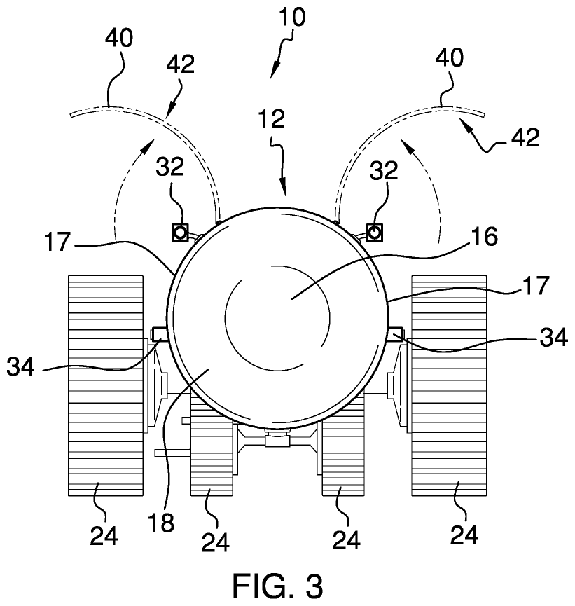

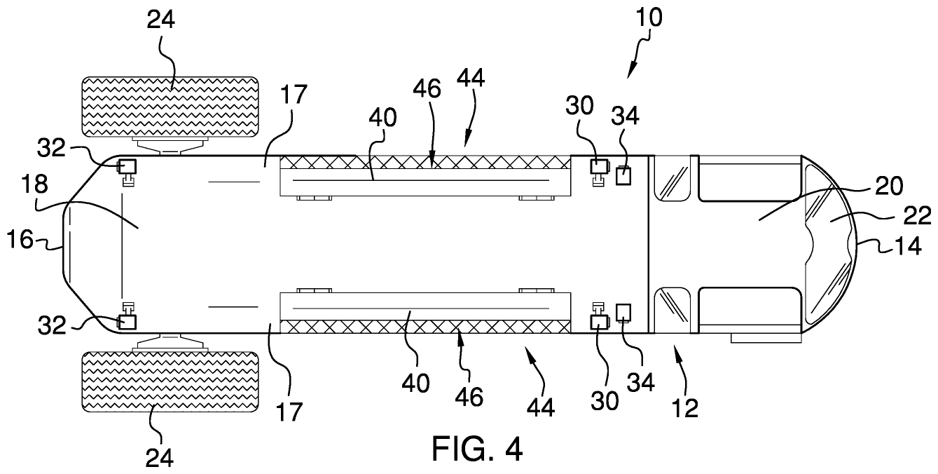

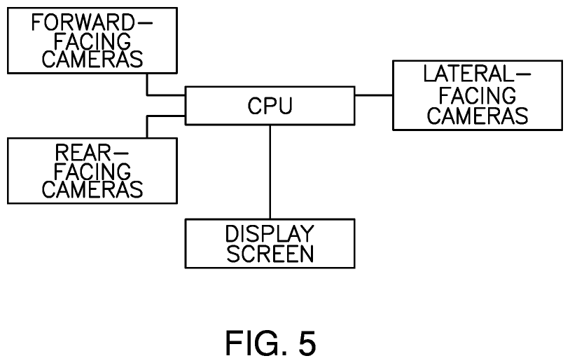

With reference now to the drawings, and in particular to FIGS. 1 through 5 thereof, a new agricultural vehicle embodying the principles and concepts of an embodiment of the disclosure and generally designated by the reference numeral 10 will be described.

As best illustrated in FIGS. 1 through 5, the agricultural vehicle 10 generally comprises a body 12 which is sized and configured to fit between rows of plants 48. The plants 48 are typically trees in an orchard but may be any plants 48 separated into rows. In some cases, the body 12 is sized and shaped such that an overhanging portion of each plant 48 extends over the body 12 when the agricultural vehicle 10 is driven between the rows. The body 12 is elongated between a front end 14 and a rear end 16 and comprises a main portion 18 and a cabin 20. The cabin 20 is coupled to and positioned forwardly of the main portion 18. A front wall 22 of the cabin 20 comprises a transparent material so that a user positioned in the cabin 20 may see forwardly through the front wall 22. A plurality of wheels 24 is mounted to the body 12. The wheels 24 are sized, positioned, and configured to fit between the rows of plants 48. The wheels 24 may also be configured to travel under the overhanging portions of the plants 48 when the agricultural vehicle 10 is driven between the rows. One or more of the wheels 24 may extend horizontally outwardly from the body 12 or may be inset from an exterior of the body 12.

A drive system 26 is mounted in the main portion 18 of the body 12 and is operatively coupled to at least one of the plurality of wheels 24. The drive system 26 may comprise an internal combustion engine but may comprise an electric motor or any other suitable drive for urging the at least one wheel 24 to turn. A suitable transmission may operatively couple the drive system 26 to the at least one wheel 24. A control system 28 is mounted in the cabin 20 of the body 12 and is operatively coupled to the drive system 26. The control system 28 may comprise pedals and hydraulics or other suitable inputs for controlling a speed of the at least one wheel 24. The control system 28 may also comprise a steering wheel or other suitable steering mechanism operatively coupled to the drive system 26 or the wheels 24 to facilitate steering the agricultural vehicle 10.

A plurality of cameras is mounted on the exterior of the body 12, and each camera is oriented to face outwardly from the body 12. The plurality of cameras includes a pair of forward-facing cameras 30, a pair of rear-facing cameras 32, and a pair of lateral-facing cameras 34. The forward-facing cameras 30 are mounted on lateral sides of the body 12 and are positioned on the main portion 18 of the body 12 adjacent to the cabin 20. The rear-facing cameras 32 are mounted on the lateral sides of the body 12 and are positioned on the main portion 18 adjacent to the rear end 16 of the body 12. The lateral-facing cameras 34 are mounted to the lateral sides of the body 12 and face in opposite lateral directions with respect to the body 12.

A processor 36 is operatively coupled to the plurality of cameras. A display 38 is mounted in the cabin 20 and is operably coupled to the processor 36. The processor 36 is configured to cause the display 38 to present images captured by the cameras of an entire perimeter region surrounding the body 12. The images may be a video stream transmitted in real time from the cameras to the display 38, recorded video stored on a memory in communication with the processor 36, or still images. The images may be a composite of images captured by each camera or may be separated from each other.

A pair of doors 40 is mounted to the main portion 18 of the body 12. Each door 40 is positioned on an associated lateral side 17 of the pair of lateral sides 17 of the body 12. Each door 40 is movable between an open position 42 and a closed position 44 to facilitate selective access to the drive system 26. Each door 40 is pivotably joined to the body 12 at a top edge of the door 40 but may be mounted via any suitable means. The doors 40 have vents 46 to facilitate air flow between a surrounding atmosphere and an interior of the body 12. In other embodiments, the body 12 contains vents in addition to or alternate to the vents 46 of the doors 40. A tow hitch may be mounted to the rear end 16 of the body 12 to facilitate the agricultural vehicle 10 towing trailers, which may have agricultural equipment mounted thereon.

In use, the agricultural vehicle 10 is driven between the rows of plants 48. The area surrounding the agricultural vehicle 10 is monitored by the user as the user drives the agricultural vehicle 10 from within the cabin 20. The user makes driving decisions based on the information provided by the images transmitted from the cameras to the display 38. For example, the user may ensure that the agricultural vehicle 10 will not collide with any portion of any of the plants 48 or with other individuals traveling near the agricultural vehicle 10. The agricultural vehicle 10 may tow a trailer in order to hold and move agricultural equipment, including harvesting mechanisms or storage bins or the like. The drive system 26 is accessible via the doors 40 for maintenance, replacement, and the like.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An agricultural vehicle comprising:
a body, the body being sized and configured to fit between rows of plants, the body being elongated between a front end and a rear end, the body comprising a main portion and a cabin, the cabin being coupled to and positioned forwardly of the main portion;
a plurality of wheels mounted to the body, the plurality of wheels being sized, positioned, and configured to fit between the rows of plants;
a drive system mounted in the main portion of the body, the drive system being operatively coupled to at least one of the plurality of wheels;
a control system mounted in the cabin of the body, the control system being operatively coupled to the drive system;
a plurality of cameras mounted on an exterior of the body, the plurality of cameras being oriented to face outwardly from the body;
a processor operatively coupled to the plurality of cameras; and
a display mounted in the cabin and operably coupled to the processor, the processor being configured to cause the display to present images captured by the plurality of cameras of an entire perimeter region surrounding the body.

2. The vehicle of claim 1, wherein the plurality of cameras includes a pair of forward-facing cameras, each forward-facing camera being mounted to an associated lateral side of a pair of lateral sides of the body, each forward-facing camera being positioned on the main portion of the body adjacent to the cabin, each forward-facing camera facing forwardly with respect to the body.

3. The vehicle of claim 1, wherein the plurality of cameras includes a pair of rear-facing cameras, each rear-facing camera being mounted to an associated lateral side of a pair of lateral sides of the body, each rear-facing camera being positioned adjacent to the rear end of the body, each rear-facing camera facing rearwardly with respect to the body.

4. The vehicle of claim 1, wherein the plurality of cameras includes a pair of lateral-facing cameras, each lateral-facing camera being mounted to an associated lateral side of a pair of lateral sides of the body, each lateral-facing camera facing in an associated one of a pair of opposite lateral directions with respect to the body.

5. The vehicle of claim 1, further comprising a door mounted to the main portion of the body and positioned on one of a pair of lateral sides of the body, the door being movable to facilitate access to the drive system.

6. The vehicle of claim 5, wherein the door is one of a pair of doors mounted to the main portion of the body, each door being positioned on an associated lateral side of the pair of lateral sides of the body, each door being movable to facilitate access to the drive system.

7. The vehicle of claim 5, wherein the door is pivotably joined to the body at a top edge of the door.

8. The vehicle of claim 1, wherein a front wall of the cabin comprises a transparent material.

9. An agricultural vehicle comprising:
a body, the body being sized and configured to fit between rows of plants, the body being elongated between a front end and a rear end, the body comprising a main portion and a cabin, the cabin being coupled to and positioned forwardly of the main portion, a front wall of the cabin comprising a transparent material;
a plurality of wheels mounted to the body, the plurality of wheels being sized, positioned, and configured to fit between the rows of plants;
a drive system mounted in the main portion of the body, the drive system being operatively coupled to at least one of the plurality of wheels;
a control system mounted in the cabin of the body, the control system being operatively coupled to the drive system;
a plurality of cameras mounted on an exterior of the body, the plurality of cameras being oriented to face outwardly from the body, the plurality of cameras including:
a pair of forward-facing cameras, each forward-facing camera being mounted to an associated lateral side of a pair of lateral sides of the body, each forward-facing camera being positioned on the main portion of the body adjacent to the cabin, each forward-facing camera facing forwardly with respect to the body;
a pair of rear-facing cameras, each rear-facing camera being mounted to an associated lateral side of the pair of lateral sides of the body, each rear-facing camera being positioned adjacent to the rear end of the body, each rear-facing camera facing rearwardly with respect to the body; and
a pair of lateral-facing cameras, each lateral-facing camera being mounted to an associated lateral side of the pair of lateral sides of the body, each lateral-facing camera facing in an associated one of a pair of opposite lateral directions with respect to the body;
a processor operatively coupled to the plurality of cameras;
a display mounted in the cabin and operably coupled to the processor, the processor being configured to cause the display to present images captured by the plurality of cameras of an entire perimeter region surrounding the body; and
a pair of doors mounted to the main portion of the body, each door being positioned on an associated lateral side of the pair of lateral sides of the body, each door being movable to facilitate access to the drive system, each door being pivotably joined to the body at a top edge of the door.
